(19) United States
(12) Patent Application Publication
(10) Pub. No.: US 2017/0361570 A1
(43) Pub. Date: Dec. 21, 2017

(54) DRAWABLE ADHESIVE TAPE AND DRAWABLE ADHESIVE TAPE PRODUCT

(71) Applicant: NINGDE AMPEREX TECHNOLOGY LIMITED, Ningde City (CN)

(72) Inventors: Jibin GENG, Ningde City (CN); Fei WU, Ningde City (CN); Liangzhen XIAO, Ningde City (CN); Wei LU, Ningde City (CN)

(73) Assignee: NINGDE AMPEREX TECHNOLOGY LIMITED, Ningde City (CN)

(21) Appl. No.: 15/598,492

(22) Filed: May 18, 2017

(30) Foreign Application Priority Data
Jun. 20, 2016 (CN) 201610450154.X

(51) Int. Cl. B32B 7/12; B32B 3/30

(52) U.S. Cl. CPC B32B 7/12; B32B 3/30; B32B 2405/00; B32B 2307/748

(57) ABSTRACT

A drawable adhesive tape and a drawable adhesive tape product. The drawable adhesive tape includes: a base framework extending along length direction of the drawable adhesive tape and having a plurality of adhesive-accommodating regions which extend along both thickness direction of the drawable adhesive tape toward interior of the base framework and length direction of the drawable adhesive tape and which are arranged at intervals along width direction of the drawable adhesive tape, and an adhesive layer filled in the adhesive-accommodating regions. The drawable adhesive tape product includes a release paper and the drawable adhesive tape, in which, a surface of the drawable adhesive tape where the adhesive-accommodating regions are located is covered by an oily surface of the release paper. The drawable adhesive tape and drawable adhesive tape product have improved tensile strength and improved adhesion strength.

### CROSS-REFERENCE TO RELATED APPLICATIONS

The present application claims priority to Chinese Patent Application No. 201610450154.X, filed on Jun. 20, 2016, the content of which is incorporated herein by reference in its entirety.

### TECHNICAL FIELD

The present application relates to the field of adhesive products and, particularly, relates to a drawable adhesive tape and a drawable adhesive tape product.

### BACKGROUND

With the development of the society, an integral structure with built-in battery pack is widely adopted by electronic products such as cellphones and tablet PCs, such that there is a need to fix the battery pack into the interior of the cellphone shell. Generally, the battery pack can be adhesively fixed with the cellphone shell via a drawable adhesive tape.

The drawable adhesive tape which is drawable and removable is a new type of drawable adhesive tape with high pressure-sensitive adhesion performance and strong adhesion force, which is clean and traceless and will not damage the surface of the adhered article when being removed, and thus is advantageous to disassembly and maintenance of the built-in battery of the electronic products. The present drawable adhesive tape product generally consists of a base material layer and a pressure-sensitive adhesive layer. The pressure-sensitive adhesive layer provides effective adhesion force and loses the adhesion force after being drew; the base material layer serves as a framework structure providing mechanical strength which guarantees that the drawable adhesive tape will not fracture when being drew and detached therefrom along its length direction.

However, the base material layer in existing products is usually designed as a band-shaped structure with a rectangular cross section and a uniform thickness. With such structural design, if the base material layer is designed too thin, the drawable adhesive tape cannot have sufficient tensile strength and will readily fracture when being drew; however, if the base material is designed too thick, the integral thickness of the drawable adhesive tape will be increased, which is disadvantageous to the utilization of the internal space of electronic products.

### SUMMARY

The present application provides a drawable adhesive tape and a drawable adhesive tape product which are capable of solving the above-mentioned problems.

A first aspect of the present application provides a drawable adhesive tape, including:

a base framework extending along a length direction of the drawable adhesive tape and having a plurality of adhesive-accommodating regions which extend along both a thickness direction of the drawable adhesive tape toward an interior of the base framework and the length direction of the drawable adhesive tape and which are arranged at intervals along a width direction of the drawable adhesive tape; and

an adhesive layer filled in the adhesive-accommodating regions.

Preferably, the adhesive-accommodating regions are located at a side of the base framework perpendicular to the thickness direction of the drawable adhesive tape.

Preferably, the adhesive-accommodating regions are located at both sides of the base framework perpendicular to the thickness direction of the drawable adhesive tape.

Preferably, the adhesive-accommodating regions located at both sides of the base framework are oppositely arranged one to one.

Preferably, the adhesive-accommodating regions located at both sides of the base framework extend along the thickness direction of the drawable adhesive tape until the base framework is penetrated through, so as to divide the base framework into a plurality of separate parts.

Preferably, a cross section of the separate part perpendicular to the length direction of the drawable adhesive tape is shaped in a square.

Preferably, a cross section of the separate part perpendicular to the length direction of the drawable adhesive tape is shaped in a circle.

Preferably, the base framework comprises a base layer and a plurality of ribs which are provided on a surface of the base layer perpendicular to the thickness of the drawable adhesive tape, and the base framework and two adjacent ribs together form one of the adhesive-accommodating regions.

Preferably, a surface of the base framework where the adhesive-accommodating regions are located is covered by the adhesive layer.

A second aspect of the present application provides a drawable adhesive tape product including a release paper and the drawable adhesive tape,

in which a surface of the drawable adhesive tape where the adhesive-accommodating regions are located is covered by an oily surface of the release paper.

Preferably, the release paper has only one oily surface at a single side.

Preferably, the release paper has one oily surface at each side.

The technical solution of the present application can achieve the following beneficial effect:

Since the base framework is provided with the adhesive-accommodating regions, the drawable adhesive tape and drawable adhesive tape product provided by the present application can have, on one hand, improved tensile strength and, on the other hand, improved adhesion strength without changing the integral thickness.

It should be appreciated that, the general description above and the detailed description below are merely exemplary and not used to limit the present application.

### BRIEF DESCRIPTION OF DRAWINGS

FIG. 1 is a perspective view of an end surface of a drawable adhesive tape, a side of which is provided with adhesive-accommodating regions, according to an embodiment of the present application;

FIGS. 2-4 are structural schematic diagrams of an end surface of a drawable adhesive tape, both sides of which are provided with adhesive-accommodating regions, according to an embodiment of the present application,

in which an adhesive layer 12 in FIG. 2 is merely filled in the adhesive-accommodating regions, while the adhesive layer 12 in FIG. 3 and FIG. 4 further covers the surface of a base framework and the thickness of the adhesive layer in FIG. 3 is smaller than the thickness of the adhesive layer in FIG. 4;

FIG. 5 and FIG. 6 are perspective views of an end surface of a drawable adhesive tape, of which the adhesive-accommodating regions penetrate through the base framework, according to an embodiment of the present application,

in which a cross section of the separate part of the base framework is square in FIG. 5, while a cross section of the separate portion of the base framework is circular in FIG. 6;

FIG. 7 is a schematic diagram of a drawable adhesive tape product containing a single-surface drawable adhesive tape which is being peeled;

FIG. 8 is a schematic diagram of a drawable adhesive tape product containing a double-surface drawable adhesive tape which is being peeled.

### REFERENCE SIGNS

1—drawable adhesive tape;
10—base framework;
   100—base layer;
   102—rib;
12—adhesive layer;
14—adhesive-accommodating region;

2—release paper;
20—oily surface.

The accompanying drawings herein are incorporated into the description and constitute a part of the description, which show embodiments of the present application and serve to explain the present application together with the description.

### DESCRIPTION OF EMBODIMENTS

The present application is described in further details in connection with embodiments thereof with reference to the accompanying drawings incorporated. The expressions “front”, “rear”, “left”, “right”, “top” and “bottom” all refer to the placement states of the drawable adhesive tape and the drawable adhesive tape product in the drawings.

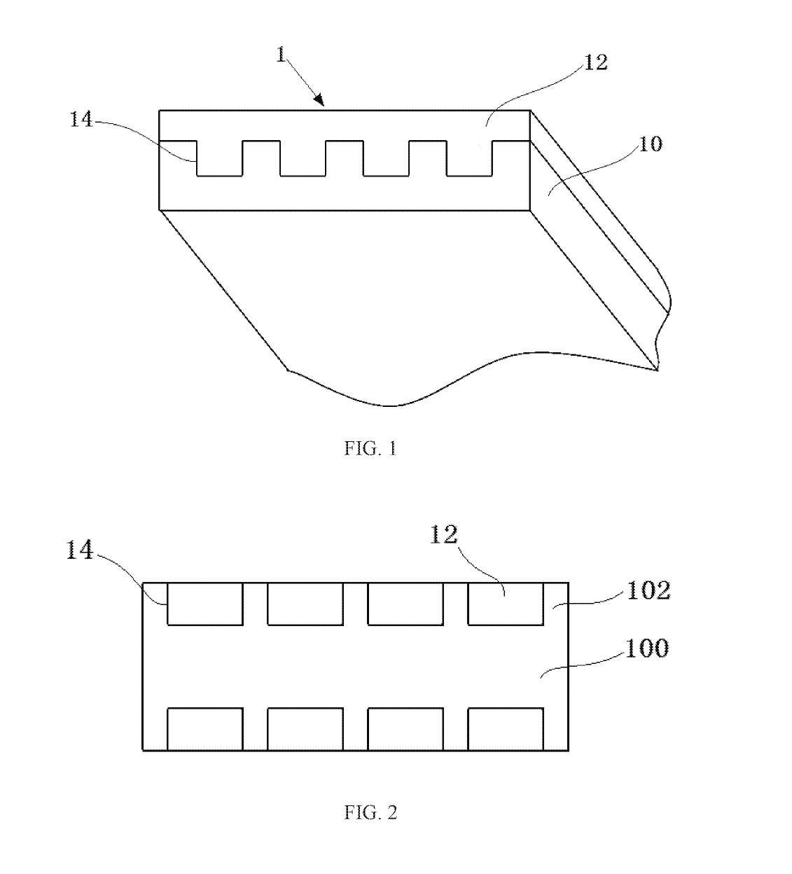

As shown in FIG. 1, the present application provides a drawable adhesive tape 1, including a base framework 10 and an adhesive layer 12. The base framework 10 extends along a length direction of the drawable adhesive tape 1, the base framework 10 mainly serves as a carrier for adhesives and provides high tensile strength for the drawable adhesive tape 1. The adhesive layer 12 is configured for adhesive fixation with other articles.

In the present embodiment, a novel technical solution of the base framework 10 is adopted in order to improve tensile strength without increasing the integral thickness of the drawable adhesive tape 1. The key point of the solution is to provide a plurality of adhesive-accommodating regions 14 in the interior of the base framework 10 which extend along a thickness direction of the drawable adhesive tape 1 toward the interior of the base framework 10, and at the same time extend along a length direction of the drawable adhesive tape 1. These adhesive-accommodating regions 14 can be arranged at intervals along a width direction of the drawable adhesive tape 1, and the adhesive layer 12 is filled in these adhesive-accommodating regions 14.

With these adhesive-accommodating regions 14, the base framework 10 provided by the present application can have a more complicated structure as compared with the base material layer with a rectangular cross section of the prior art, and the adhesive layer 12 will, after being filled into the adhesive-accommodating regions 14, form an intersecting arrangement structure with the base framework 10, so as to enhance the interaction force between the adhesive layer 12 and the base framework 10 and thus improve the overall tensile strength of the base framework 10. Moreover, since the adhesive layer 12 can be filled into the adhesive-accommodating regions 14, the thickness of the adhesive layer 12 can be made thinner than that of the prior art without affecting the adhesion strength, and thus the thickness of the base framework 10 can be increased accordingly, so as to further improve the tensile strength, or the thickness of the adhesive layer 12 may be increased so as to obtain much higher adhesion strength.

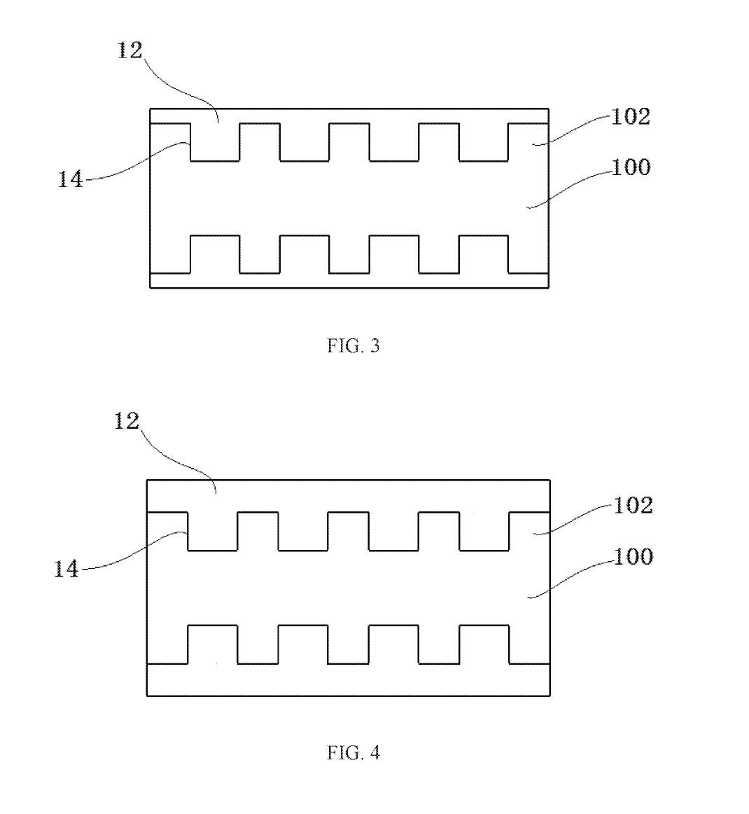

If the article to be adhered has a smooth surface, there is no need for too much adhesive, such that only the adhesive-accommodating regions 14 may be fully filled with the adhesive layer 12, and there is no need for the adhesive to cover areas other than the adhesive-accommodating regions 14 (see FIG. 2). If the article to be adhered has a rough surface, sufficient adhesive is necessary for adhering, such that not only the adhesive-accommodating regions 14 is fully filled with the adhesive layers 12, but also the surface of the base framework 10 where the adhesive-accommodating regions 14 are presented is covered by the adhesive layer 12 (see FIG. 3 and FIG. 4). Or, the amount of the adhesive may be adjusted by varying the interval distance and width of the adhesive-accommodating regions 14.

In the present embodiment, the adhesive-accommodating regions 14 filled with the adhesive layers 12 may be only presented at one side of the base framework 10 perpendicular to the thickness direction of the drawable adhesive tape 1, so as to form a single-surface drawable adhesive tape (see FIG. 1); or the adhesive-accommodating regions 14 filled with the adhesive layer 12 may be presented at both sides of the base framework 10 perpendicular to the thickness direction of the drawable adhesive tape 1, so as to form a double-surface drawable adhesive tape (see FIGS. 2-6).

Whether it is a single-surface drawable adhesive tape or a double-surface drawable adhesive tape, the adhesive-accommodating regions 14 thereof can be formed by adopting the following solution. Specifically, the base framework 10 includes a base layer 100 and a plurality of ribs 102 which are provided on a surface of the base layer 100 perpendicular to the thickness direction of the drawable adhesive tape 1, and the base layer 100 and two adjacent ribs 102 together form one of the adhesive-accommodating regions 14. In this situation, the ribs 102 and the base layer 100 can be integrally formed by the same material, or the ribs 102 and the base layer 100 can be respectively formed and then connected together by hot-melting or other manners.

As for the double-surface drawable adhesive tape, the adhesive-accommodating regions 14 are presented at both sides of the base framework 10, and the adhesive-accommodating regions 14 at the two sides may be intersecting with each other or oppositely arranged one by one. When the adhesive-accommodating regions 14 at the two sides are arranged opposite to each other, the adhesive-accommodating regions 14 at the two sides may, at the same time, extend toward the interior of the base framework 10, such that the portion of the base framework 10 between the adhesive-accommodating regions 14 at the two sides may become thinning. In fact, such thinning portion may finally disappear such that the adhesive-accommodating regions 14 at the two sides will be directly communicated, so as to divide the base framework 10 into a plurality of separate parts, which can still achieve the object of enhancing the tensile strength as well as significantly increase the amount of the adhesive.

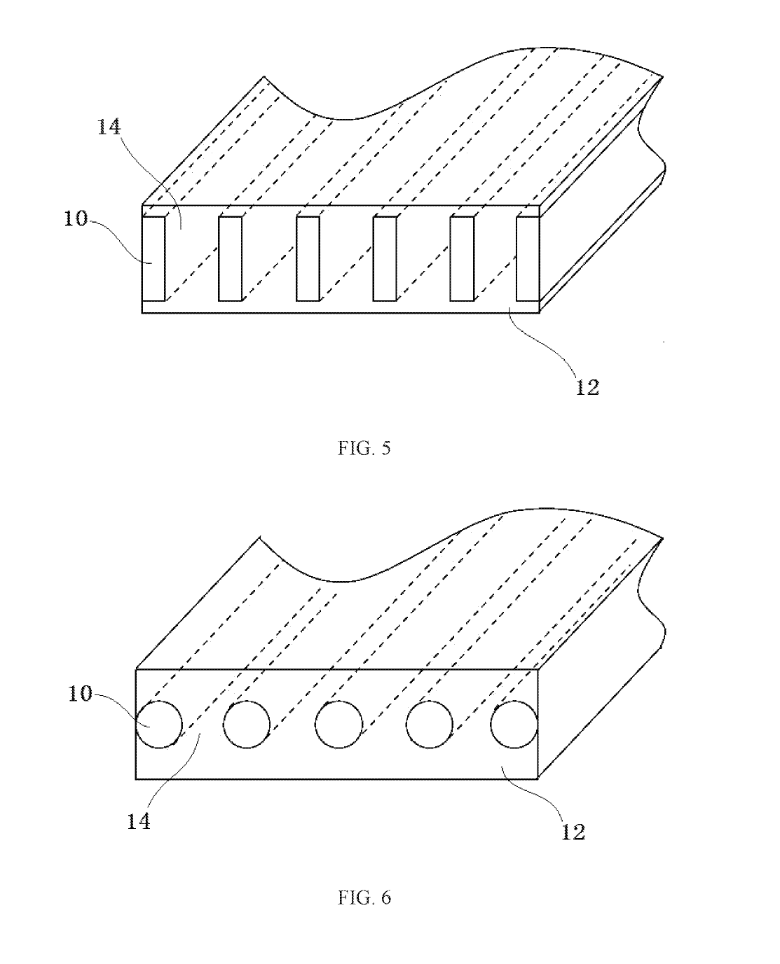

As for the drawable adhesive tape 1 with the above-mentioned configuration, these separate parts are of bar-shaped structures which are embedded into the adhesive layer 12. The cross sections of these separate parts perpendicular to the length direction of the drawable adhesive tape 1 may adopt various shapes, such as a square (see FIG. 5), a circle (see FIG. 6), etc.

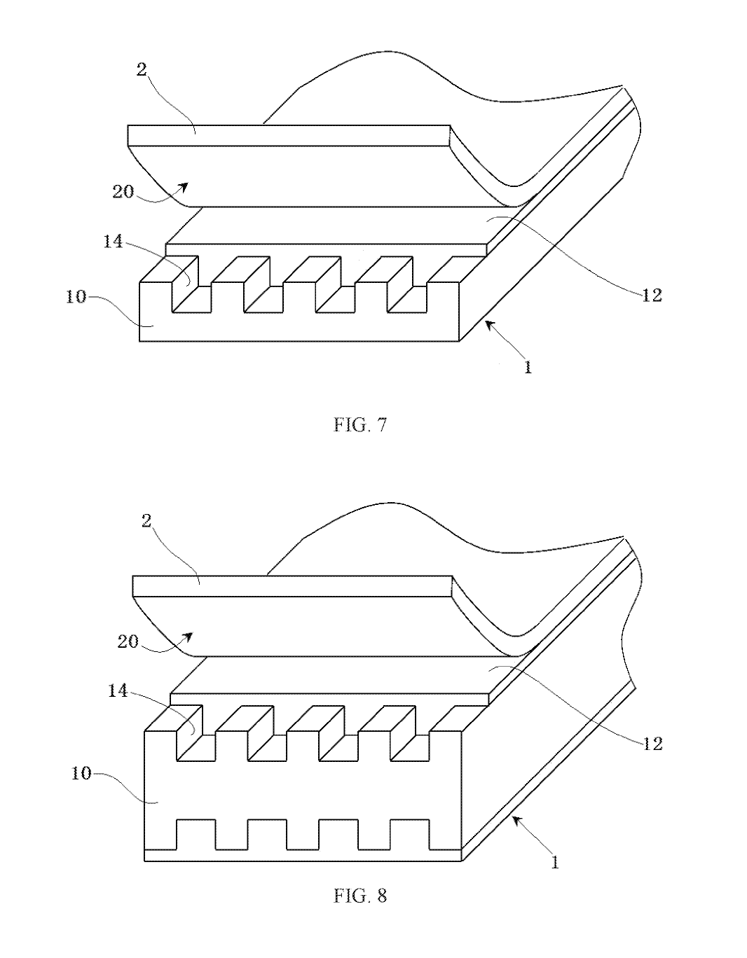

Another embodiment of the present application further provides a drawable adhesive tape product, as shown in FIG. 7 and FIG. 8, including a release paper 2 and the drawable adhesive tape 1 as described in the preceding embodiment. The release paper 2 has at least one oily surface 20 which is configured to cover the surface of the drawable adhesive tape 1 where the adhesive-accommodating regions 14 are presented. The release paper 2 with a single oily surface is sufficient for the single-surface drawable adhesive tape in a way that the surface of the drawable adhesive tape 1 where the adhesive-accommodating regions 14 are presented is covered by the oily surface 20; as for the double-surface drawable adhesive tape, a release paper 2 with two oily surfaces is necessary in a way that one of the surfaces of the drawable adhesive tape 1 is covered by one of the two oily surfaces of the release paper 2 (see FIG. 8) and then the drawable adhesive tape 1 covered with the release paper 2 is winded for deposit. Generally, the adhesive layer 12 on the drawable adhesive tape 1 is covered by the release paper 2 for protection and convenient access; when being used, the release paper 2 can be peeled off from the drawable adhesive tape 1 so as to expose the adhesive layer 12 of the drawable adhesive tape 1 for adhering with articles.

The drawable adhesive tape and drawable adhesive tape product provided by the present application have, on one hand, improved tensile strength and, on the other hand, improved adhesion strength.

The above are merely preferred embodiments of the present application, which are not used to limit the present application, and those skilled in the art may make various changes and modifications to the present application. All the amendments, equivalent substitutes and improvements within the spirit and principles of the present application shall fall into the protection scope the present application.

What is claimed is:

1. A drawable adhesive tape, comprising:
a base framework extending along a length direction of the drawable adhesive tape and having a plurality of adhesive-accommodating regions which extend along both a thickness direction of the drawable adhesive tape toward an interior of the base framework and the length direction of the drawable adhesive tape and which are arranged at intervals along a width direction of the drawable adhesive tape; and
an adhesive layer filled in the adhesive-accommodating regions.

2. The drawable adhesive tape according to claim 1, wherein the adhesive-accommodating regions are located at a side of the base framework perpendicular to the thickness direction of the drawable adhesive tape.

3. The drawable adhesive tape according to claim 1, wherein the adhesive-accommodating regions are located at both sides of the base framework perpendicular to the thickness direction of the drawable adhesive tape.

4. The drawable adhesive tape according to claim 3, wherein the adhesive-accommodating regions located at both sides of the base framework are oppositely arranged one to one.

5. The drawable adhesive tape according to claim 4, wherein the adhesive-accommodating regions located at both sides of the base framework extend along the thickness direction of the drawable adhesive tape until the base framework is penetrated through, so as to divide the base framework into a plurality of separate parts.

6. The drawable adhesive tape according to claim 5, wherein a cross section of the separate part perpendicular to the length direction of the drawable adhesive tape is shaped in a square.

7. The drawable adhesive tape according to claim 5, wherein a cross section of the separate part perpendicular to the length direction of the drawable adhesive tape is shaped in a circle.

8. The drawable adhesive tape according to claim 1, wherein the base framework comprises a base layer and a plurality of ribs which are provided on a surface of the base layer perpendicular to the thickness of the drawable adhesive tape, and the base framework and two adjacent ribs together form one of the adhesive-accommodating regions.

9. The drawable adhesive tape according to claim 1, wherein a surface of the base framework where the adhesive-accommodating regions are located is covered by the adhesive layer.

10. A drawable adhesive tape product, comprising a release paper and the drawable adhesive tape according to claim 1,
wherein a surface of the drawable adhesive tape where the adhesive-accommodating regions are located is covered by an oily surface of the release paper.
